(19) United States
(12) Patent Application Publication
(10) Pub. No.: US 2019/0348942 A1
(43) Pub. Date: Nov. 14, 2019

(54) VIRTUAL VERIFICATION SYSTEM AND DRIVE CONTROLLER

(71) Applicant: Mitsubishi Electric Corporation, Tokyo (JP)

(72) Inventors: Yasuo ONODERA, Tokyo (JP); Masaya HARAKAWA, Tokyo (JP); Hiroatsu FUKUOKA, Tokyo (JP); Yuji IGARASHI, Tokyo (JP)

(73) Assignee: Mitsubishi Electric Corporation, Tokyo (JP)

(21) Appl. No.: 16/347,593

(22) PCT Filed: Feb. 6, 2017
(86) PCT No.: PCT/JP2017/004202

§ 371 Date: May 6, 2019

(51) Int. Cl. H02P 29/00; G06F 17/50

(52) U.S. Cl. CPC H02P 29/00; G06F 2217/02; G06F 17/5009

(57) ABSTRACT

A virtual verification system according to the present invention includes a real-time simulator; and a drive controller that can be connected to the real-time simulator in a virtual verification mode, and is capable of driving an electric motor in an actual operation mode. The drive controller includes an output unit that supplies electrical power to the electric motor in the actual operation mode, and outputs a signal corresponding to a virtual verification model installed in the real-time simulator in the virtual verification mode.

### FIELD

The present invention relates to a virtual verification system including a simulator capable of simulating an electric motor and a mechanical device, and a drive controller capable of driving the electric motor in the virtual verification system.

### BACKGROUND

In the industrial world, applications of model-based development that utilizes simulation models in each phase of product design are expanding. For example, in a case where model-based development is applied to the development of a drive controller that controls an electric motor, the electric motor to be controlled is virtualized, and is simulated by a real-time simulator. In a case where the electric motor is connected to a mechanical device, the mechanical device is also to be controlled, and is simulated by the real-time simulator. As the drive controller and the real-time simulator form a closed loop, the functions and performance of the drive controller can be evaluated as if the drive controller were connected to the actual target to be controlled. Hereinafter, the electric motor to be controlled by the drive controller, or the electric motor and the mechanical device to be controlled by the drive controller will be also referred to as the device(s) to be controlled.

Advantageous aspects of the above method include enabling verification of a drive controller combined with a model such as a virtual electric motor model or a virtual mechanical model before a device to be controlled is experimentally manufactured, enabling a great reduction in the number of drive controller evaluation steps by virtualizing a device to be controlled and thus eliminating the need to prepare a large-size device to be controlled, enabling unmanned continuous drive evaluation by not actuating the device to be controlled, and the like.

Meanwhile, Patent Literature 1 discloses a technique for enabling a simulation more similar to an actual operating state by forming a simulation apparatus including a control device to be developed and a real-time simulation device that simulates a device to be controlled by the control device. This simulation apparatus has the following configuration. The control device disclosed in Patent Literature 1 includes: a state quantity input means that inputs state quantities output by the real-time simulation device; a computation means that computes a predetermined control command in accordance with the state quantities; and a control command output means that outputs the control command to the real-time simulation device. Further, the real-time simulation device disclosed in Patent Literature 1 includes: a control command input means that inputs a control command after the control command output from the control device is determined; a simulation means that performs computation to simulate an operation of the device to be controlled, in accordance with the control command; and a state quantity output means that outputs the state quantities to the control device before a state quantity input to the control device is made, in accordance with the simulated operation. As described above, by the technique described in Patent Literature 1, the control device and the real-time simulation device are synchronized in terms of input/output interface operations, so that the delay for a response at a time of actual device control can be reduced. Thus, it becomes possible to simulate a situation more similar to an actual operating state.

### CITATION LIST

### Patent Literature

Patent Literature 1: Japanese Patent Application Laid-Open No. 2010-44486

### SUMMARY

### Technical Problem

A drive controller for an electric motor is regarded as a virtual verification target, and the electric motor drives a mechanical device. If the technique disclosed in Patent Literature 1 is applied in this case, the control device of Patent Literature 1 corresponds to a drive controller that includes a control circuit and an electrical circuit, and the targets to be controlled according to Patent Literature 1 correspond to an electric motor and a mechanical device connected to the electric motor. The control circuit performs control computations of the position, the speed, and the current of the electric motor, generates pulse width modulation (PWM) signals, and controls the electrical circuit with the PWM signals. The electric motor is supplied with electrical power from the electrical circuit, and converts the electrical power into power to drive the mechanical device.

Because electrical power is supplied from the electrical circuit of the drive controller to the electric motor as described above, the electric motor is connected to the electrical circuit of the drive controller. Therefore, in a case where the technique disclosed in Patent Literature 1 is applied, an output signal interface circuit in Patent Literature 1 is connected to the electrical circuit inside the drive controller, and three-phase voltages is output from the output signal interface circuit.

In a case where virtual verification of the drive controller is performed, on the other hand, simulation models of the electrical circuit of the drive controller, the electric motor, and the mechanical device might be mounted in a real-time simulator. In this case, the PWM signals necessary for computation of a simulation model of the electrical circuit needs to be sent from the drive controller. However, in a case where the technique disclosed in Patent Literature 1 is applied as described above, only three-phase voltages is output from the output signal interface circuit, and the PWM signals necessary for computing a simulation model of the electrical circuit at a time of virtual verification cannot be output from the drive controller.

Because the manufacturer of the drive controller understands the circuit specification inside the drive controller, the manufacturer can extract PWM signals with a jumper wire or the like. However, extracting PWM signals with a jumper wire or the like is troublesome. Furthermore, a user of the drive controller whose internal circuit specification is not disclosed cannot extract the PWM signals necessary for computing a simulation model from the drive controller, and therefore, cannot conduct virtual verification.

The present invention has been made in view of the above, and aims to obtain a virtual verification system that can readily perform virtual verification in accordance with a simulation model of the device to be controlled.

### Solution to Problem

To solve the above problems and achieve the objective, a virtual verification system according to the present invention includes: a real-time simulator; and a drive controller that can be connected to the real-time simulator in a virtual verification mode, and is capable of driving an electric motor in an actual operation mode. The drive controller includes an output unit that supplies electrical power to the electric motor in the actual operation mode, and outputs a signal corresponding to a virtual verification model mounted in the real-time simulator in the virtual verification mode.

### Advantageous Effects of Invention

A virtual verification system according to the present invention has an effect to enable easy virtual verification depending on a simulation model of the device to be controlled.

### BRIEF DESCRIPTION OF DRAWINGS

FIG. 1 is a diagram illustrating an example configuration of a virtual verification system according to a first embodiment.

FIG. 2 is a diagram illustrating an example configuration of a control computing unit according to the first embodiment.

FIG. 3 is a diagram illustrating an example configuration of a control circuit according to the first embodiment.

FIG. 4 is a flowchart illustrating an example operation of the control computing unit according to the first embodiment.

FIG. 5 is a diagram illustrating an example configuration of a virtual verification system according to a second embodiment.

FIG. 6 is a diagram illustrating an example configuration of a virtual verification system according to a third embodiment.

FIG. 7 is a diagram illustrating a virtual verification system according to the third embodiment having a different example configuration from that illustrated in FIG. 6.

FIG. 8 is a diagram illustrating an example configuration of a virtual verification system according to a fourth embodiment.

FIG. 9 is a block diagram illustrating the virtual verification system according to the fourth embodiment.

FIG. 10 is a conceptual diagram illustrating downloading of an electrical circuit model or the like from a cloud server into an information processing device in the fourth embodiment.

### DESCRIPTION OF EMBODIMENTS

The following is a detailed description of virtual verification systems and drive controllers according to embodiments of the present invention, with reference to the drawings. It should be noted that the present invention is not limited by the embodiments.

### First Embodiment

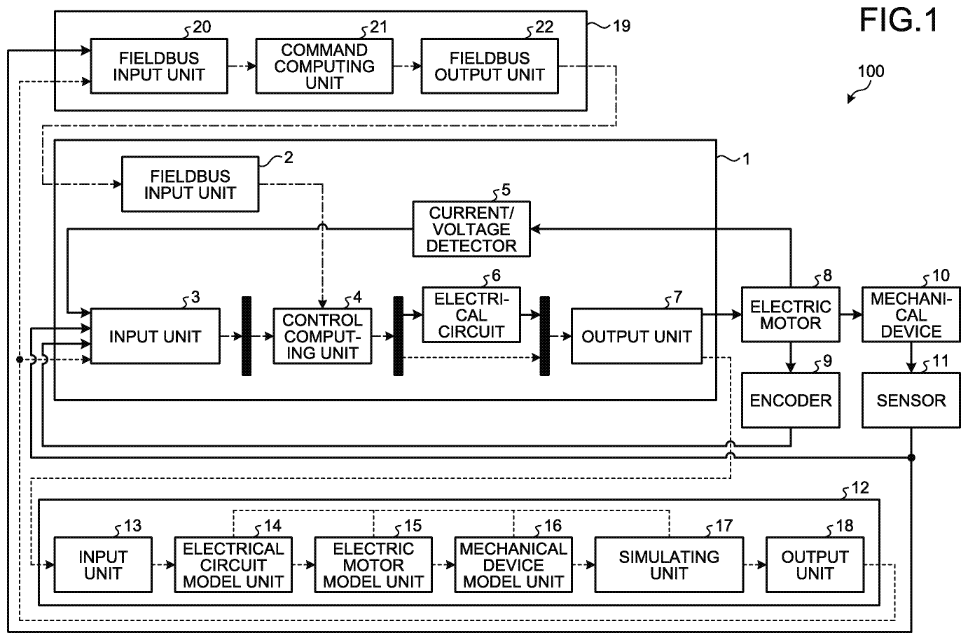

FIG. 1 is a diagram illustrating an example configuration of a virtual verification system according to a first embodiment of the present invention. As illustrated in FIG. 1, a virtual verification system 100 of the present embodiment includes a mechanical device 10, an electric motor 8 that drives the mechanical device 10, a drive controller 1 that controls the electric motor 8; and a controller 19 that gives a control command to the drive controller 1. The virtual verification system 100 further includes an encoder 9 that measures a rotational angle of the electric motor 8, a sensor 11 that measures the position, speed, acceleration, and the like of the mechanical device 10, and a real-time simulator 12 that performs a simulation model computation in real time. The mechanical device 10 is a machine tool, an industrial robot, or manufacturing equipment, for example.

The virtual verification system 100 according to the present embodiment has an actual operation mode in which the drive controller 1 drives the electric motor 8, and a virtual verification mode in which the drive controller 1 is connected to the real-time simulator 12 and performs virtual verification. In a case where the virtual verification system 100 operates in the actual operation mode, the drive controller 1 and the controller 19 are set to the actual operation mode. In a case where the virtual verification system 100 operates in the virtual verification mode, the drive controller 1 and the controller 19 are set to the virtual verification mode. The real-time simulator 12 is not used in the actual operation mode, but is used in the virtual verification mode. The drive controller 1 can be connected to the real-time simulator 12, and is capable of driving the electric motor 8. In the actual operation mode, the drive controller 1 is connected to the electric motor 8. In the virtual verification mode, the drive controller 1 is connected to the real-time simulator 12.

The controller 19 includes a fieldbus input unit 20 that receives an input of a signal from a device such as the sensor 11, a command computing unit 21 that computes a control command for the drive controller 1, and a fieldbus output unit 22 that sends the control command to the drive controller 1. The fieldbus input unit 20 receives an input from the sensor 11 in the actual operation mode, and receives an input from the real-time simulator 12 in the virtual verification mode. Any method may be used in setting a mode in the controller 19, that is, setting the actual operation mode or the virtual verification mode in which the fieldbus input unit 20 is to operate. The mode setting in the controller 19 may be performed by operating an input device such as a switch (not illustrated), or by the fieldbus input unit 20 determining the presence/absence of connection of the real-time simulator 12 and setting a mode in accordance with a result of the determination, for example.

The drive controller 1 includes a fieldbus input unit 2 that receives an input of a control command sent from the controller 19, an input unit 3 that includes a general-purpose input interface, a control computing unit 4 that performs a control computation for the electric motor 8, an electrical circuit 6 that supplies electrical power to the electric motor 8, a current/voltage detector 5 that detects the current and the voltage of the electric motor 8, and an output unit 7 that includes a general-purpose output interface. The electrical circuit 6 is an inverter or a servo amplifier including a switching element. The electrical circuit 6 is controlled by pulse width modulation signals (PWM signals) output from the control computing unit 4, and supplies the electrical power for driving the electric motor 8 to the electric motor 8 via the output unit 7. In the actual operation mode, the input unit 3 receives an input from a device such as the sensor 11 or the encoder 9. In the virtual verification mode, the input unit 3 receives an input from the real-time simulator 12. In the actual operation mode, the output unit 7 applies electrical power to the electric motor 8. In the virtual verification mode, the output unit 7 outputs a signal to be used in virtual verification as will be described later to the real-time simulator 12. In the actual operation mode, the control computing unit 4 drives the electric motor 8. In the virtual verification mode, the control computing unit 4 is connected to the real-time simulator 12, and performs virtual verification.

Specifically, in the actual operation mode, the input unit 3 receives an input of a result of state measurement performed on the electric motor 8. In the virtual verification mode, the input unit 3 receives an input of simulation information about a simulated state of the electric motor 8 from the real-time simulator 12. In the actual operation mode, the control computing unit 4 generates pulse width modulation signals in accordance with the result of the state measurement performed on the electric motor 8, and outputs pulse modulation signals. In the virtual verification mode, the control computing unit 4 generates a signal to be used in virtual verification in accordance with the simulation information, and outputs the signal to be used in virtual verification. In the actual operation mode, the output unit 7 outputs the electrical power output from the electrical circuit 6 to the electric motor 8. In the virtual verification mode, the output unit 7 outputs the signal to be used in virtual verification to the real-time simulator 12.

Any method may be used in setting a mode in the drive controller 1, or setting the actual operation mode, that is, the virtual verification mode in which the drive controller 1 is to operate. The mode setting in the drive controller 1 may be performed by operating an input device such as a switch (not illustrated), or may be automatically performed depending on whether the real-time simulator 12 is connected to an input interface for virtual verification among the input interfaces of the input unit 3.

Specifically, in a case where the real-time simulator 12 is not connected to the input interface for virtual verification, the input unit 3 sets the mode of the drive controller 1 to the actual operation mode. In a case where the real-time simulator 12 is connected to the input interface for virtual verification, the input unit 3 sets the mode of the drive controller 1 to the virtual verification mode.

The real-time simulator 12 includes an input unit 13 including a general-purpose input interface, an electrical circuit model unit 14, an electric motor model unit 15, a mechanical device model unit 16, a simulating unit 17 that performs simulations of these simulation models, and an output unit 18 including a general-purpose output interface. The electrical circuit model unit 14 calculates a response simulating the electrical circuit 6 using an electrical circuit model that is a simulation model simulating the electrical circuit 6 of the drive controller 1. The electric motor model unit 15 calculates a response simulating the electric motor 8 using an electric motor model that is a simulation model simulating the electric motor 8. The mechanical device model unit 16 calculates a response simulating the mechanical device 10 using a mechanical device model that is a simulation model simulating the mechanical device 10. In the description below, installing modules for computing responses with simulation models each of which simulates corresponding one of the devices which are the virtual verification targets, such as the electrical circuit model unit 14, the electric motor model unit 15, and the mechanical device model unit 16, in the real-time simulator 12, will be referred to as installing simulation models of the devices in the real-time simulator 12.

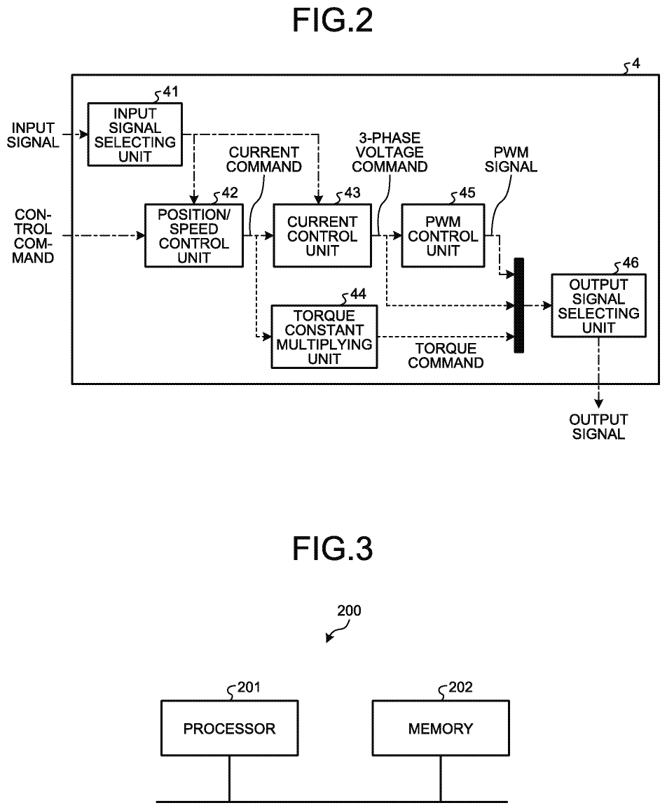

FIG. 2 is a diagram illustrating an example configuration of the control computing unit 4 according to the first embodiment. The control computing unit 4 includes an input signal selecting unit 41 that selects an input signal in accordance with the set mode, a position/speed control unit 42 that performs position and speed control computations, a current control unit 43 that performs a current control computation, a torque constant multiplying unit 44 that calculates a torque command from a current command, a PWM control unit 45 that generates PWM signals from three-phase voltage commands, and an output signal selecting unit 46 that selects an output signal in accordance with the set mode.

In FIG. 1, of the signal lines connecting the components, the solid lines are the wiring lines to be used in the actual operation mode, the dashed lines are the wiring lines to be used in the virtual verification mode, and the dot-and-dash lines are the wiring lines to be used both in the actual operation mode and the virtual verification mode. In FIG. 2, of the signal lines inside the control computing unit 4, the dot-and-dash lines are the wiring lines to be used both in the actual operation mode and the virtual verification mode, and the dashed lines are the wiring lines to be used in the virtual verification mode.

In the example configuration illustrated in FIG. 1, the controller 19, the real-time simulator 12, and the drive controller 1 are connected by a fieldbus. A fieldbus is a network that is used for industrial use or the like, and is a network based on CC-Link IE (registered trademark), for example. The connection configuration of the controller 19, the real-time simulator 12, and the drive controller 1 is not limited to the above example, and any connection configuration may be adopted, regardless of wired or wireless connection.

Next, the hardware configuration of each device in the virtual verification system of the present embodiment is described. The fieldbus input unit 20 of the controller 19 includes an input interface such as a connector or a port, and a processing circuit. The command computing unit 21 of the controller 19 is realized by a processing circuit. The fieldbus output unit 22 includes an output interface such as a connector or a port, and a processing circuit.

The fieldbus input unit 2 of the drive controller 1 includes an input interface such as a connector or a port, and a processing circuit. The output unit 7 of the drive controller 1 includes an output interface such as a connector or a port, and a processing circuit. The current/voltage detector 5 is a detector. The electrical circuit 6 is an electrical circuit such as an inverter as described above. The control computing unit 4 is realized by a processing circuit.

The input unit 13 of the real-time simulator 12 includes an input interface such as a connector or a port, and a processing circuit. The output unit 18 of the real-time simulator 12 includes an output interface such as a connector or port, and a processing circuit. The electrical circuit model unit 14, the electric motor model unit 15, the mechanical device model unit 16, and the simulating unit 17 are formed with processing circuits.

Some or all of the above described input interfaces and output interfaces may be wireless communication circuits. The processing circuits described above may be dedicated hardware, or may be control circuits each including a processor. Alternatively, each processing circuit may be a combination of dedicated hardware and a control circuit. Further, the components may be realized by processing circuits different to one another, or a plurality of components may be formed with one processing circuit.

In a case where the processing circuits are realized by dedicated hardware, the processing circuits may be formed with application specific Integrated circuits (ASIC), a field programmable gate array (FPGA), or a combination thereof.

In a case where a processing circuit is formed with a control circuit including a processor, this control circuit may be a control circuit 200 having a configuration illustrated in FIG. 3, for example. FIG. 3 is a diagram illustrating an example configuration of the control circuit 200 according to the present embodiment. The control circuit 200 includes a processor 201 and a memory 202. The processor is a central processing unit (CPU) (also referred to as a central processing device, a processing device, an arithmetic device, a microprocessor, a microcomputer, a processor, or a digital signal processor (DSP)) or the like. The memory is a nonvolatile or volatile semiconductor memory such as a random access memory (RAM), a read only memory (ROM), or a flash memory), a magnetic disk, or the like, for example. Further, the control circuit 200 may be a system-on-a chip (SoC).

In a case where each processing circuit is the control circuit 200 including a processor, the processing circuit is realized by the processor 201 reading and executing a program that is stored in the memory 202 and stores the procedures to be performed by the components. The memory 202 is also used as a temporary memory in each process performed by the processor 201.

Note that electrical circuit model computations normally need to be performed at very short sampling intervals. Therefore, in cases where an electrical circuit model is installed in the real-time simulator 12, an FPGA is often used as the processing circuit for performing computations in real time.

Next, operations according to the first embodiment are described, with reference to FIGS. 1 and 2. In the virtual verification system 100 according to the first embodiment, the control computing unit 4 operates differently in the actual operation mode and in the virtual verification mode. In the actual operation mode, the control computing unit 4 applies electrical power to the electric motor 8. In the virtual verification mode, the control computing unit 4 outputs an output signal corresponding to a simulation model installed in the real-time simulator 12. Therefore, it is not necessary to use a jumper wire or the like, and, even if the internal circuit configuration of the drive controller 1 is not clear, virtual verification of the device to be controlled can be easily performed.

In the description below, operations are explained separately for the actual operation mode and for the virtual verification mode. First, an operation in the actual operation mode is described. In the controller 19 illustrated in FIG. 1, the fieldbus input unit 20 receives an input of sensor information from the sensor 11, and outputs the received center information to the command computing unit 21. As described above, the sensor 11 measures physical states of the mechanical device 10, and sends physical state quantities that are the measurement results as the sensor information to the input unit 3 of the drive controller 1 and the fieldbus input unit 20 of the controller 19. Specific examples of the sensor 11 include a position sensor, a speed sensor, an acceleration sensor, a force sensor, and the like. The type of the sensor 11 is appropriately selected in accordance with the controlled quantity.

The command computing unit 21 calculates a control command for the drive controller 1 in accordance with the sensor information. Although FIG. 1 illustrates one drive controller 1, it can be configured such that a plurality of drive controllers 1 is connected to one controller 19, a plurality of electric motors is driven by the plurality of drive controllers 1, and the mechanical device 10 is driven by the plurality of electric motors. In a case where a plurality of drive controllers 1 are connected to the controller 19, the controller 19 calculates a control command for the drive controllers 1 to synchronously and cooperatively perform control so that the mechanical device 10 performs a desired operation. The control command calculated by the command computing unit 21 is output from the fieldbus output unit 22, and is input to the drive controller 1 through the fieldbus input unit 2.

A conventional method may be used as a method of calculating the control command in the command computing unit 21, and therefore, detailed explanation thereof is not made herein. The fieldbus output unit 22 of the controller 19 sends the control command calculated by the command computing unit 21 to the fieldbus input unit 2 of the drive controller 1.

The fieldbus input unit 2 of the drive controller 1 sends the control command received from the fieldbus output unit 22 to the control computing unit 4. The encoder 9 measures the rotational angle or the position of the electric motor, and sends the measurement result to the input unit 3 of the drive controller 1. The measurement result from the current/voltage detector 5 and the measurement result from the encoder 9 are an example of a result of electric motor state measurement for detecting the current and the voltage of the electric motor 8. The current/voltage detector 5 measures the current and the voltage of the electric motor 8, and sends the measurement result to the input unit 3 of the drive controller 1. The input unit 3 of the drive controller 1 sends the control computing unit 4 the current and the voltage of the electric motor 8, which are the measurement result received from the current/voltage detector 5, the rotational angle of the electric motor 8, which is the measurement result received from the encoder 9, and the physical state quantities of the mechanical device 10, which are the sensor information measured by the sensor 11.

An operation of the control computing unit 4 is now described, with reference to FIG. 2. The position/speed control unit 42 receives the control command sent from the fieldbus input unit 2. The input signal selecting unit 41 receives the current and the voltage of the electric motor 8, the rotational angle of the electric motor 8, and the physical state quantities of the mechanical device 10, which are sent from the input unit 3.

From the input information, the input signal selecting unit 41 selects and sends the current and the voltage of the electric motor 8 to the current control unit 43, selects and sends the rotational angle of the electric motor 8 to the position/speed control unit 42, and selects and sends the physical state quantities of the mechanical device 10 to the position/speed control unit 42 and the current control unit 43. The position/speed control unit 42 calculates the rotational speed by differentiating the rotational angle of the electric motor 8 sent from the input signal selecting unit 41, and calculates the current command by performing position and speed control computations, using the rotational angle of the electric motor 8, the control command send from the fieldbus input unit 2, and the rotational speed. Proportional integral differential (PID) control is performed as an example of the position and speed control computations, but the position and speed control computations are not limited to this. The position/speed control unit 42 sends the calculated current command to the current control unit 43.

The current control unit 43 calculates the three-phase voltage commands by performing a current control computation using the current command sent from the position/speed control unit 42 and the current and the voltage of the electric motor 8 sent from the input signal selecting unit 41, and sends the three-phase voltage commands to the PWM control unit 45. PID control is performed as an example of the current control computation, but the current control computation is not limited to this. The physical state quantities of the mechanical device 10 are used for correction and the like in the control computation in the position/speed control unit 42 and the current control unit 43. Any method may be used as a method of correction in the control computation using the physical state quantities of the mechanical device 10, or correction in the control computation using the physical state quantities of the mechanical device 10 is not necessarily performed.

In the example described above, the encoder 9 is connected to the electric motor 8, and the rotational angle of the electric motor 8 is fed back to the drive controller 1. However, the encoder 9 is not necessarily connected to the electric motor 8. Likewise, in the embodiment described above, the sensor 11 is connected to the mechanical device 10, and the physical state quantities of the mechanical device 10 are fed back to the drive controller 1 and the controller 19. However, the sensor 11 is not necessarily connected to the mechanical device 10. In a case where the encoder 9 is not connected to the electric motor 8, the control computing unit 4 performs computation without using the rotational angle, or performs computation by estimating the rotational angle by an estimation algorithm. In a case where the sensor 11 is not connected to the mechanical device 10, the command computing unit 21 and the control computing unit 4 perform computation without using the sensor information, or perform computation by estimating the physical state quantities by an estimation algorithm.

The PWM control unit 45 converts the three-phase voltage commands sent from the current control unit 43 into PWM signals for driving the switching element in the electrical circuit 6 illustrated in FIG. 1, and sends the PWM signals to the output signal selecting unit 46. In the actual operation mode, the output signal selecting unit 46 sends the PWM signals sent from the PWM control unit 45 to the electrical circuit 6.

The electrical circuit 6 performs switching in accordance with the PWM signals sent from the control computing unit 4, to supply electrical power to the electric motor 8 via the output unit 7. The electric motor 8 converts the electrical power supplied from the electrical circuit 6 into rotational or linear motion, to cause the mechanical device 10 to operate.

As described above, in the actual operation mode, the drive controller 1 calculates the control operation quantity for causing the electric motor 8 and the mechanical device 10 to perform desired operations, using results of measurement of the states of the electric motor 8 and the mechanical device 10, which are results of measurement conducted by the sensor 11, the encoder 9, and the current/voltage detector 5, as feedback signals. The drive controller 1 then supplies this control operation quantity as electrical power to the electric motor 8, to drive the electric motor 8 and the mechanical device 10.

Next, an operation in the virtual verification mode is described. In the virtual verification mode, the drive controller 1 is not connected to the electric motor 8, but is connected to the real-time simulator 12.

Some or all of the electrical circuit model, the electric motor model, and the mechanical device model are installed in the real-time simulator 12, in accordance with the content of the virtual verification. FIG. 1 illustrates an example in which the electrical circuit model, the electric motor model, and the mechanical device model are all installed in the real-time simulator 12. Accordingly, the real-time simulator 12 includes the electrical circuit model unit 14, the electric motor model unit 15, and the mechanical device model unit 16, which correspond to the models.

The simulation models installed in the real-time simulator 12 can be changed by being downloaded from a server or the like (not illustrated) through a model downloading interface (not illustrated). Through the model downloading interface, modules corresponding to the simulation models are downloaded from the server or the like, and, in accordance with the content to be verified, setting of the simulation models to be implemented, and the levels of detail of the simulation models are changed. The modules corresponding to the simulation models are processing units that simulate responses of the simulation models, and the electrical circuit model unit 14, the electric motor model unit 15, and the mechanical device model unit 16 are an example of these processing units. Note that the server holds a plurality of modules corresponding to a plurality of simulation models having different levels of detail.

A signal necessary for virtual verification is output from the output unit 7 of the drive controller 1, in accordance with the simulation models installed in the real-time simulator 12 as described later. The input unit 13 of the real-time simulator 12 sends the signal sent from the output unit 7 of the drive controller 1 to one of the electrical circuit model unit 14, the electric motor model unit 15, and the mechanical device model unit 16 by a method that will be described later. The simulating unit 17 performs a simulation by causing the electrical circuit model unit 14, the electric motor model unit 15, and the mechanical device model unit 16 to operate at a predetermined sampling time. Note that, while the simulation is performed, state quantities are exchanged among the electrical circuit model unit 14, the electric motor model unit 15, and the mechanical device model unit 16.

The simulating unit 17 sends simulation results to the output unit 18. Specifically, the simulation results to be sent to the output unit 18 include the current, the voltage, the rotational angle, and the rotational speed of the electric motor model simulating a response of the electric motor 8 output from the electric motor model unit 15, and the physical state quantities of the mechanical device model simulating a response of the mechanical device 10 output from the mechanical device model unit 16. Out of these simulation results, the output unit 18 sends the physical state quantities of the mechanical device model to the drive controller 1 and the controller 19, and sends the current, the voltage, the rotational angle, and rotational speed of the electric motor model to the drive controller 1.

Note that the electric motor model is not necessarily installed in the real-time simulator 12. In a case where the electric motor model is not installed in the real-time simulator 12, the current, the voltage, the rotational angle, and the rotational speed of the electric motor model are not sent to the drive controller 1. However, if the control computing unit 4 of the drive controller 1 calculates and outputs a torque command, instead of the current control unit 43 performing a computation, the current and the voltage of the electric motor model become unnecessary. Furthermore, if the physical quantities of the mechanical device model unit 16 include a rotational angle and a rotational speed, the rotational angle and the rotational speed of the mechanical device model unit 16 can be substituted for the rotational angle and the rotational speed required in the position/speed control unit 42.

The physical state quantities of the mechanical device model sent from the real-time simulator 12 to the controller 19 are input from the fieldbus input unit 20 as if they were actually-measured signals from the actual mechanical device 10. The command computing unit 21 of the controller 19 regards the physical state quantities of the mechanical device model input from the fieldbus input unit 20 as actually-measured sensor information. The command computing unit 21 then calculates a control command, and sends the control command to the fieldbus output unit 22. The control command sent from the command computing unit 21 is sent from the fieldbus output unit 22 to the drive controller 1 as in the actual operation mode.

The current, the voltage, the rotational angle, and rotational speed of the electric motor model sent from the real-time simulator 12 to the drive controller 1, and the physical state quantities of the mechanical device model, are input via the input unit 3 as if they were actually-measured signals.

The input unit 3 sends the current, the voltage, the rotational angle, and the rotational speed of the electric motor model, and the physical state quantities of the mechanical device model, to the control computing unit 4. The operation of the control computing unit 4 is now described in detail, with reference to FIG. 2. The control command input from the fieldbus input unit 2 is sent to the position/speed control unit 42. The current, the voltage, the rotational angle, and rotational speed of the electric motor model, as well as the physical state quantities of the mechanical device model input from the input unit 3 are sent to the input signal selecting unit 41.

Out of the input signals, the input signal selecting unit 41 selects and sends the current and the voltage of the electric motor model to the current control unit 43, selects and sends the rotational angle and the rotational speed of the electric motor model to the position/speed control unit 42, and selects and sends the physical state quantities of the mechanical device model to the position/speed control unit 42 and the current control unit 43.

Using the control command sent from the fieldbus input unit 2, and the rotational angle and the rotational speed of the electric motor model sent from the input signal selecting unit 41, the position/speed control unit 42 calculates a current command by performing position and speed control computations, and sends the current command to the current control unit 43.

The current control unit 43 calculates three-phase voltage commands by performing a current control computation using the current command sent from the position/speed control unit 42 and the current and the voltage of the electric motor model sent from the input signal selecting unit 41, and sends the three-phase voltage commands to the PWM control unit 45. The physical state quantities of the mechanical device model are used for correcting the control computation and the like in the position/speed control and the current control. However, as described above, the physical state quantities of the mechanical device model are not necessarily required.

The PWM control unit 45 converts the three-phase voltage commands sent from the current control unit 43 into PWM signals necessary for simulating a switching operation of an inverter circuit in the electrical circuit model, and outputs the PWM signals to the output signal selecting unit 46. In addition to that, in the virtual verification mode, the current command calculated by the position/speed control unit 42 is also sent to the torque constant multiplying unit 44. The torque constant multiplying unit 44 converts the current command into a torque command, and outputs the torque command to the output signal selecting unit 46. The three-phase voltage commands calculated by the current control unit 43 is also sent to the output signal selecting unit 46. The output signal selecting unit 46 sends the PWM signals, the three-phase voltage commands, and the torque command to the real-time simulator 12. As a result, in the real-time simulator 12, the PWM signals sent from the output signal selecting unit 46 can be used as an input to the electrical circuit model unit 14, the three-phase voltage commands sent from the output signal selecting unit 46 can be used as an input to the electric motor model unit 15, and the torque command can be used as an input to the mechanical device 10.

Note that, in a case where the electrical circuit model is not installed in the real-time simulator 12, it suffices that the control computing unit 4 calculates and outputs the three-phase voltage commands, and any computation by the PWM control unit 45 is not necessary. Further, in a case where the electrical circuit model and the electric motor model are not installed in the real-time simulator 12, it suffices that the control computing unit 4 calculates and outputs the torque command, and any computation by the current control unit 43 is not necessary.

In the actual operation mode, the signals to be output from the output unit 7 of the drive controller 1 are three-phase voltages output from the electrical circuit 6 that supplies electrical power to the electric motor 8. In the virtual verification mode, however, a signal that is not a three-phase voltage is output from the output unit 7. That is, in the actual operation mode, the drive controller 1 of the present embodiment outputs the electrical power to be supplied to the electric motor 8, and, in the virtual verification mode, the drive controller 1 outputs the signal to be used in virtual verification to the real-time simulator 12.

As described above, any one or all of the electrical circuit model, the electric motor model, and the mechanical device model are installed in the real-time simulator 12, in accordance with the content of the virtual verification. In a case where the electrical circuit model is installed in the real-time simulator 12, the output signal selecting unit 46 sends PWM signals necessary for simulating a switching operation of the inverter circuit in the electrical circuit model, to the output unit 7. In a case where the electrical circuit model is not installed but the electric motor model is installed in the real-time simulator 12, the output signal selecting unit 46 sends three-phase voltage commands not subjected to PWM control and necessary for causing the electric motor model to operate, to the output unit 7. In a case where the electrical circuit model and the electric motor model are not installed but the mechanical device model is installed in the real-time simulator 12, the output signal selecting unit 46 sends a torque command necessary for computation of the mechanical device model, to the output unit 7. The output unit 7 sends the signal sent from the output signal selecting unit 46 to the input unit 13 of the real-time simulator 12.

In the virtual verification mode, the drive controller 1 and the real-time simulator 12 form a closed loop in the above manner. This makes it possible to cause the drive controller 1 to operate as if being actually connected to the electric motor 8 and the mechanical device 10.

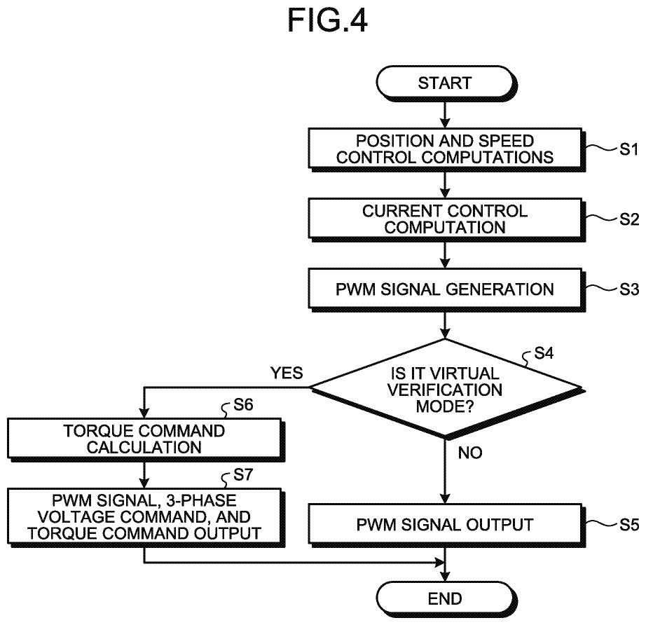

As described above, the control computing unit 4 of the present embodiment can change the signals to be output, depending on modes. FIG. 4 is a flowchart illustrating an example operation of the control computing unit 4. The control computing unit 4 performs position and speed control computations, using a control command sent from the position/speed control unit 42 through the fieldbus input unit 2 and a signal sent from the input signal selecting unit 41 (step S1). Note that the content of the signal sent from the input signal selecting unit 41 and the computation at this stage vary depending on whether which one of the actual operation mode and the virtual verification mode is set, as described above.

The control computing unit 4 performs a current control computation with the current control unit 43 (step S2). Note that the content of the signal sent from the input signal selecting unit 41 at this stage vary depending on whether which one of the actual operation mode and the virtual verification mode is set, as described above.

The control computing unit 4 generates PWM signals with the PWM control unit 45 (step S3).

Specifically, the PWM control unit 45 converts the three-phase voltage commands sent from the current control unit 43 into PWM signals.

In the case of the virtual verification mode (Yes in step S4), the torque constant multiplying unit 44 calculates a torque command by converting a current command into the torque command (step S6), and the output signal selecting unit 46 outputs the PWM signals, the three-phase voltage commands, and the torque command (step S7).

In a case where the mode is not the virtual verification mode but is the actual operation mode (No in step S4), the output signal selecting unit 46 outputs the PWM signals (step S5).

The control computing unit 4 performs the above described process when a signal is input from the input unit 3. As described above, in the virtual verification mode, part of the process illustrated in FIG. 4 may be skipped, depending on the model installed in the real-time simulator 12.

Because the real-time simulator 12 is located outside the drive controller 1, it is possible to change the specification of the real-time simulator 12 in accordance with the simulation model installed therein. To simulate an electrical circuit model by simulation, it is necessary to make the sampling time extremely short. To perform simulation with a very short sampling time in real time, it is necessary to prepare a high-performance real-time simulator. In a case where an operation of a mechanical device that is not highly responsive is to be verified, on the other hand, the electric motor model and the mechanical device model, or only the mechanical device model can be installed, to lower the specification of the real-time simulator. Thus, the evaluation cost can be reduced.

A computer in a field network connected by a fieldbus can be used as the real-time simulator 12. For example, in FIG. 1, the command computing unit 21 of the controller 19 may have the functions of the real-time simulator 12. A computer in the field network is connected to the drive controller 1, a robot, a machine tool, a remote input/output (I/O) device, various sensors, and the like via the field network, and is connected to a server and the like via Ethernet (registered trademark) or wirelessly. A computer in the field network can exchange signals required in virtual verification with the drive controller 1 via the field network, and thus, can be utilized as the real-time simulator 12 as described above. In other words, the real-time simulator 12 is a computer in a field network in this case, and, in the virtual verification mode, the drive controller 1 and the real-time simulator 12 transmit and receive signals to be used in virtual verification via the field network.

In the above configuration, at a time of virtual verification, the drive controller 1 can be easily connected to the real-time simulator 12. Accordingly, not only the manufacturer of the drive controller 1 but also even a user of the drive controller 1 can readily perform virtual verification, and it is possible to reduce the number of start-up procedures the user of the drive controller 1 needs to go through to install the device.

Meanwhile, there are commercially available drive controllers that are capable of performing a simulation simulating a simple load in the drive controller, and verifying a virtual drive operation of the drive controller, without connecting the drive controller to an electric motor. However, computing units of such a drive controller have restrictions in terms of specifications, and it is difficult to calculate a detailed and complicated simulation model in real time in the drive controller. Therefore, there is a problem in that simulation models that can be installed therein are limited to simple load models, and only simplified verification can be performed.

In the present embodiment, on the other hand, the presence/absence of a simulation model to be installed in the real-time simulator 12 and its level of detail can be changed in accordance with the content to be verified. Thus, it is possible to perform detailed and complicated verification using a simulation model that cannot be computed in real time by a control computing unit in a drive controller due to the restrictions on the specification. Further, the level of detail of a simulation model can be changed in accordance with the content to be subjected to virtual verification.

Accordingly, it is possible to perform detailed and complicated verification using a simulation model that cannot be performed by a control computing unit in a drive controller. In a case where a simple simulation model serves the purpose, the specification of the real-time simulator is lowered, and thus, the virtual verification cost can be lowered.

Further, according to the present embodiment, it is possible to perform simple or detailed real-time simulation, without connecting to an electric motor. Accordingly, it is possible to simulate an electric motor at a remote location, and it is possible to provide a user with a drive control device in a state where the setting of the drive control device compatible with the user's device has been completed. For example, in a case where the user cannot conduct verification with a detailed simulation model, it is possible to provide the user with the drive control device after performing a detailed simulation.

### Second Embodiment

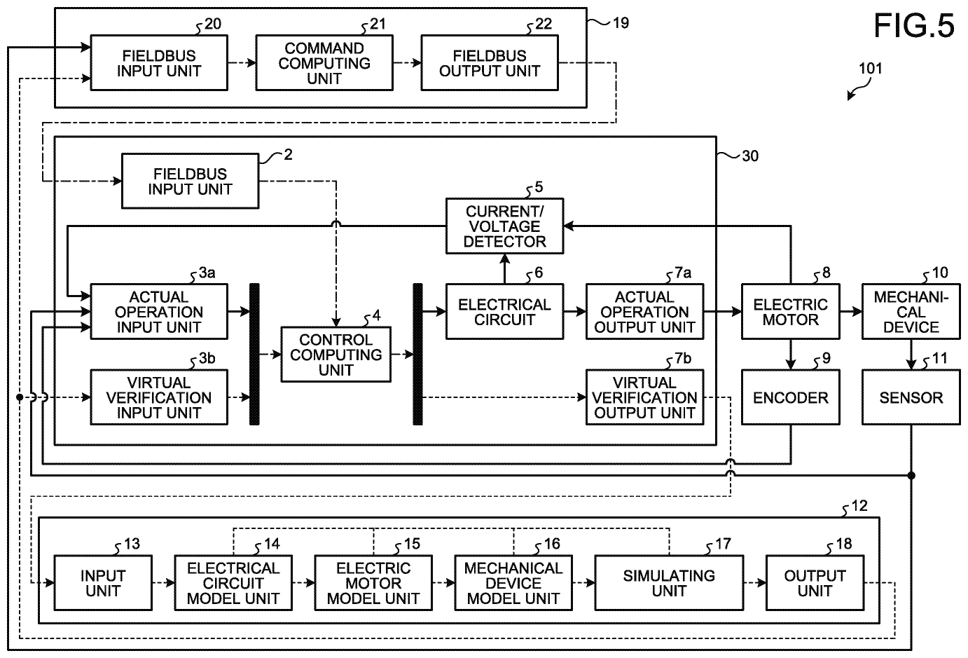

FIG. 5 is a diagram illustrating an example configuration of a virtual verification system 101 according to a second embodiment of the present invention. A virtual verification system 101 is the same as the virtual verification system 100 of the first embodiment, except for including a drive controller 30 in place of the drive controller 1. The components having the same functions as those in the first embodiment are denoted by the same reference numerals as those used in the first embodiment, and repetitive explanation is not made herein. In the description below, the differences from the first embodiment are mainly explained.

The drive controller 30 according to the second embodiment includes an actual operation input unit 3a and a virtual verification input unit 3b, in place of the input unit 3, and includes an actual operation output unit 7a and a virtual verification output unit 7b, in place of the output unit 7. In other words, in the present embodiment, the input unit is configured by the actual operation input unit 3a and the virtual verification input unit 3b, and the output unit is formed with the actual operation output unit 7a and the virtual verification output unit 7b. Other than these aspects, the drive controller 30 of the second embodiment is the same as the drive controller 1 of the first embodiment.

Next, operations according to the second embodiment are described with reference to FIG. 5, with the description focusing on differences from the first embodiment. Note that, in the description below, operations are also explained separately for the actual operation mode and for the virtual verification mode.

First, an operation in the actual operation mode is described. The current and the voltage of the electric motor 8 measured by the current/voltage detector 5, the rotational angle of the electric motor 8 measured by the encoder 9, and the physical state quantities of the mechanical device 10 measured by the sensor 11 are input to the actual operation input unit 3a. The actual operation input unit 3a sends these received signals to the control computing unit 4.

The current and the voltage of the electric motor 8 measured by the current/voltage detector 5 sent from the actual operation input unit 3a, the rotational angle of the electric motor 8 measured by the encoder 9, and the physical state quantities of the mechanical device 10 measured by the sensor 11 are input to the input signal selecting unit 41 of the control computing unit 4 illustrated in FIG. 2.

The operation of the control computing unit 4 in the actual operation mode is the same as that in the first embodiment, and therefore, explanation thereof is not made herein. Through the operation described in the first embodiment, the output signal selecting unit 46 of the control computing unit 4 in FIG. 2 sends PWM signals to the electrical circuit 6. The electrical circuit 6 performs switching in accordance with the PWM signals sent from the control computing unit 4, to supply electrical power to the electric motor 8 via the actual operation output unit 7a. The electric motor 8 converts the electrical power supplied from the electrical circuit 6 into rotational or linear motion, to cause the mechanical device 10 to operate, as in the first embodiment.

Next, an operation in the virtual verification mode is described. The current and the voltage of the electric motor model sent from the real-time simulator 12 to the drive controller 30, the rotational angle and the rotational speed of the electric motor model, and the physical state quantities of the mechanical device model are input to the virtual verification input unit 3b, as if they were actually-measured signals from the electrical circuit 6, the electric motor 8, and the mechanical device 10. The virtual verification input unit 3b sends these input signals to the control computing unit 4.

The operation of the control computing unit 4 in the virtual verification mode is the same as that in the first embodiment, and therefore, explanation thereof is omitted herein. Through the operation described in the first embodiment, the output signal selecting unit 46 of the control computing unit 4 in FIG. 2 selects a necessary signal in accordance with the simulation model installed in the real-time simulator 12, and sends the signal to the virtual verification output unit 7b.

In a case where the electrical circuit model is installed in the real-time simulator 12, the output signal selecting unit 46 sends PWM signals necessary for simulating a switching operation of an inverter circuit in the electrical circuit model, to the virtual verification output unit 7b. In a case where the electrical circuit model is not installed but the electric motor model is installed in the real-time simulator 12, the output signal selecting unit 46 sends three-phase voltage commands not subjected to PWM control and necessary for causing the electric motor model to operate, to the virtual verification output unit 7b. In a case where the electrical circuit model and the electric motor model are not installed but only the mechanical device model is installed in the real-time simulator 12, the output signal selecting unit 46 sends a torque command necessary for computation of the mechanical device model, to the virtual verification output unit 7b. The virtual verification output unit 7b sends the signal sent from the output signal selecting unit 46 to the input unit 13 of the real-time simulator 12.

Next, the virtual verification input unit 3b and the virtual verification output unit 7b are described in detail. To enable easy connection between the drive controller 30 and the real-time simulator 12, interfaces of the virtual verification input unit 3b and the virtual verification output unit 7b are preferably realized by connectors. The real-time simulator 12 may be provided as an optional board of the drive controller 30 to the user. In that case, a connector provided in the drive controller 30 and a connector provided in the real-time simulator 12 mounted on the optional board are connected. In a case where a real-time simulator 12 mounted on an optional board is provided, the real-time simulator 12 has an interface for downloading simulation models.

Alternatively, the connector provided in the drive controller 30 may be connected to the real-time simulator 12 via a connector cable. Specifically, the connector cable may be a universal serial bus (USB) cable or a local area network (LAN) cable. In that case, each of the interfaces of the virtual verification input unit 3b and the virtual verification output unit 7b is a USB connector or a LAN connector.

Further, the drive controller 30 and the real-time simulator 12 may be wirelessly connected. In that case, the input interface of the virtual verification input unit 3b and the output interface of the virtual verification output unit 7b are wireless connection interfaces.

Electrical power is supplied to the control computing unit 4 and the electrical circuit 6 from a power input unit (not illustrated) of the drive controller 30. During an actual operation, it is necessary to supply the electrical circuit 6 with a voltage higher than the voltage to be supplied to the control computing unit 4, and a voltage necessary for driving the electrical circuit 6 is input to the drive controller 30. At a time of virtual verification, on the other hand, the electrical circuit 6 is not caused to operate, and therefore, there is no need to supply a high voltage as in an actual operation. In view of this, a voltage that is lower than the voltage to be supplied during an actual operation but is high enough for an operation of the control computing unit 4 may be supplied from the virtual verification input unit 3b, so that, at a time of virtual verification, a high-voltage source does not need to be connected as in an actual operation. That is, in the virtual verification mode, a voltage lower than the power supply voltage to be supplied in the actual operation mode may be input to the drive controller.

In the above configuration, at a time of virtual verification, the drive controller 30 can be easily connected to the real-time simulator 12. Thus, the same effects as those of the first embodiment can be achieved. Further, the power consumption during virtual verification can be made smaller than the power consumption during an actual operation.

### Third Embodiment

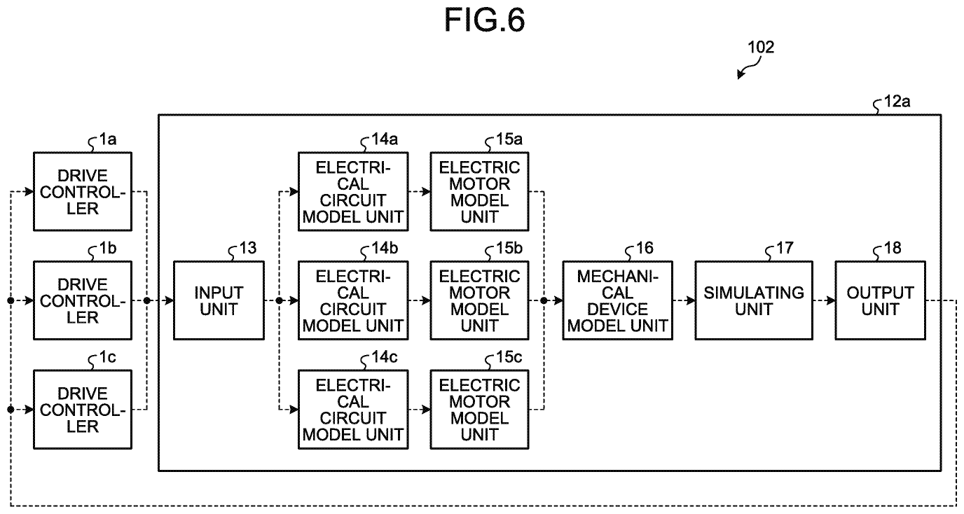

FIG. 6 is a diagram illustrating an example configuration of a virtual verification system 102 according to a third embodiment of the present invention. A virtual verification system 102 is the same as the virtual verification system 100 of the first embodiment, except for including drive controllers 1a through 1c in place of the drive controller 1, including a plurality of electric motors in place of the electric motor 8, and including a real-time simulator 12a in place of the real-time simulator 12. Note that the controller 19, the mechanical device 10, and the sensor 11 are not illustrated in the drawing. Although not illustrated in the drawing either, an electric motor is connected to each of the drive controllers 1a through 1c, and the encoder 9 is connected to each of the electric motors. The three electric motors are connected to the mechanical device 10. The drive controllers 1a through 1c are connected to different electric motors from one another. Note that FIG. 6 illustrates the connection configuration in the virtual verification mode, and dashed lines indicate portions connected in the virtual verification mode. The components having the same functions as those in the second embodiment are denoted by the same reference numerals as those used in the second embodiment, and repetitive explanation is not made herein. In the description below, the differences from the second embodiment are mainly explained.

The present embodiment concerns a virtual verification system to be used in a case where virtual verification is performed on a multiaxial mechanical device 10 being driven by a plurality of electric motors and a plurality of drive controllers. Here, a triaxial device is taken as an example. The configuration of each of the drive controllers 1a through 1c is the same as that of the drive controller 30. In the virtual verification mode, there are the following methods for connecting a plurality of drive controllers and a real-time simulator.

According to a first method, the number of channels of the input unit 13 is the same as the number of the drive controllers to be connected to the real-time simulator, as illustrated in FIG. 6. In FIG. 6, each of the virtual verification output units 7b of the drive controllers 1a through 1c is connected to the input unit 13 of the real-time simulator 12a. The real-time simulator 12a includes electrical circuit model units 14a through 14c and electric motor model units 15a through 15c corresponding to the drive controllers 1a through 1c.

PWM signals output from the drive controller 1a is sent to the electrical circuit model unit 14a via the input unit 13, PWM signals output from the drive controller 1b is sent to the electrical circuit model unit 14b via the input unit 13, and PWM signals output from the drive controller 1c is sent to the electrical circuit model unit 14c via the input unit 13. As a result, a simulation of the mechanical device model unit 16 simulating a mechanical device model having a plurality of axes is performed. Results of simulations with respect to each of the axes are sent from the output unit 18 to corresponding one of the drive controllers 1a through 1c, and the simulation results are input through the virtual verification input units 3b of the drive controllers 1a through 1c.

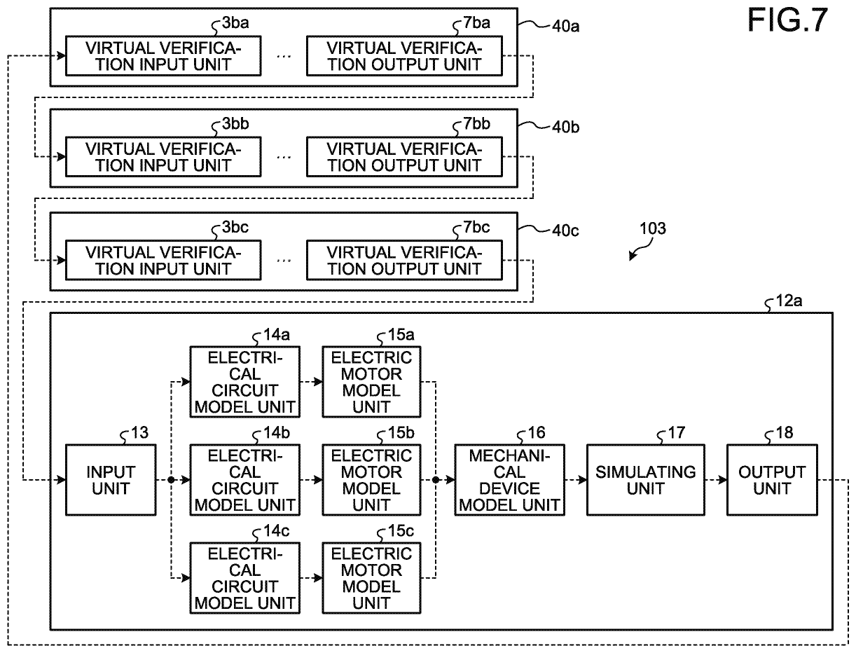

According to a second method, drive controllers 40a through 40c are connected in a daisy chain form, as illustrated in FIG. 7. FIG. 7 is a diagram illustrating another example configuration of a virtual verification system that is different from the example configuration illustrated in FIG. 6 in the present embodiment. FIG. 7 does not illustrate the controller 19, the encoder 9, the mechanical device 10, and the sensor 11, either. FIG. 7 also illustrates the connection configuration in the virtual verification mode, and dashed lines indicate portions connected in the virtual verification mode. The encoder 9 is provided in each of a plurality of electric motors. The plurality of electric motors are connected to the mechanical device 10. A virtual verification system 103 illustrated in FIG. 7 includes the drive controllers 40a through 40c in place of the drive controllers 1a through 1c. The drive controller 40a includes a virtual verification input unit 3ba in place of the virtual verification input unit 3b, and a virtual verification output unit 7ba in place of the virtual verification output unit 7b. The drive controller 40b includes a virtual verification input unit 3bb in place of the virtual verification input unit 3b, and a virtual verification output unit 7bb in place of the virtual verification output unit 7b. The drive controller 40c includes a virtual verification input unit 3bc in place of the virtual verification input unit 3b, and a virtual verification output unit 7bc in place of the virtual verification output unit 7b. Other than these aspects, the configuration of the drive controller 40a is the same as the drive controller 30 of the second embodiment.

The virtual verification output unit 7ba of the drive controller 40a is connected to the virtual verification input unit 3bb of the drive controller 40b, the virtual verification output unit 7bb of the drive controller 40b is connected to the virtual verification input unit 3bc of the drive controller 40c, the virtual verification output unit 7bc of the drive controller 40c is connected to the input unit 13 of the real-time simulator 12a, and the output unit 18 of the real-time simulator 12 is connected to the virtual verification input unit 3ba of the drive controller 40a.

From the output unit 18 of the real-time simulator 12a, simulation results with respect to the respective axes are sent, together with the axis numbers, to the virtual verification input unit 3ba of the drive controller 40a. In accordance with the simulation result of the axis number corresponding to the drive controller 40a, the drive controller 40a generates PWM signals necessary for computation of the electrical circuit model unit 14a, and sends the PWM signals from the virtual verification output unit 7ba to the virtual verification input unit 3bb of the drive controller 40b. At this stage, the simulation results with respect to the axes output from the real-time simulator 12a are also sent.

In accordance with the simulation result of the axis number corresponding to the drive controller 40b, the drive controller 40b generates PWM signals necessary for computation of the electrical circuit model unit 14b, and sends the PWM signals from the virtual verification output unit 7bb to the virtual verification input unit 3bc of the drive controller 40c. At this stage, the PWM signals output from the drive controller 40a and the simulation results with respect to the axes output from the real-time simulator 12a are also sent.

In accordance with the simulation result of the axis number corresponding to the drive controller 40c, the drive controller 40c generates PWM signals necessary for computation of the electrical circuit model unit 14c, and sends the PWM signals from the virtual verification output unit 7bc to the input unit 13 of the real-time simulator 12a. At this stage, the PWM signals output from the drive controller 40a and the drive controller 40b are also sent.

The input unit 13 of the real-time simulator 12a refers to the axis numbers, and sends the PWM signals output from the drive controller 40a to the electrical circuit model unit 14a, the PWM signals output from the drive controller 40b to the electrical circuit model unit 14b, and the PWM signals output from the drive controller 40c to the electrical circuit model unit 14c. A simulation of the mechanical device model unit 16 having a plurality of axes is performed. The simulation results with respect to the axes are sent together with the axis numbers from the output unit 18 to the virtual verification input unit 3ba of the drive controller 40a.

Although the case where all of the electrical circuit models, the electric motor models, and the mechanical device model are installed in the real-time simulator 12a has been described, three-phase voltage commands not to be subjected to PWM control are sent in place of PWM signals in a case where any electrical circuit model is not installed but the electric motor models are installed in the real-time simulator 12a, and a torque command is sent in a case where any electrical circuit model and any electric motor model are not installed but only the mechanical device model is installed in the real-time simulator 12, as described above. Operations other than those described above are the same as those in the second embodiment.

Note that, instead of the same drive controller 30 as that of the second embodiment, the same drive controller 1 as that of the first embodiment may be used as each of the drive controllers 1a through 1c.

Although three drive controllers and three electric motors are used in the above described example, the operation and the configuration according to the present embodiment can also be applied in a case where there are a plurality of drive controllers, and one electric motor is controlled by the plurality of drive controllers.

With the above configuration, even in a case where a plurality of drive controllers and a plurality of electric motors are included, the drive controllers 1a through 1c or 40a through 40c can be easily connected to the real-time simulator 12a at a time of virtual verification. Thus, the same effects as those of the first embodiment can be achieved.

### Fourth Embodiment

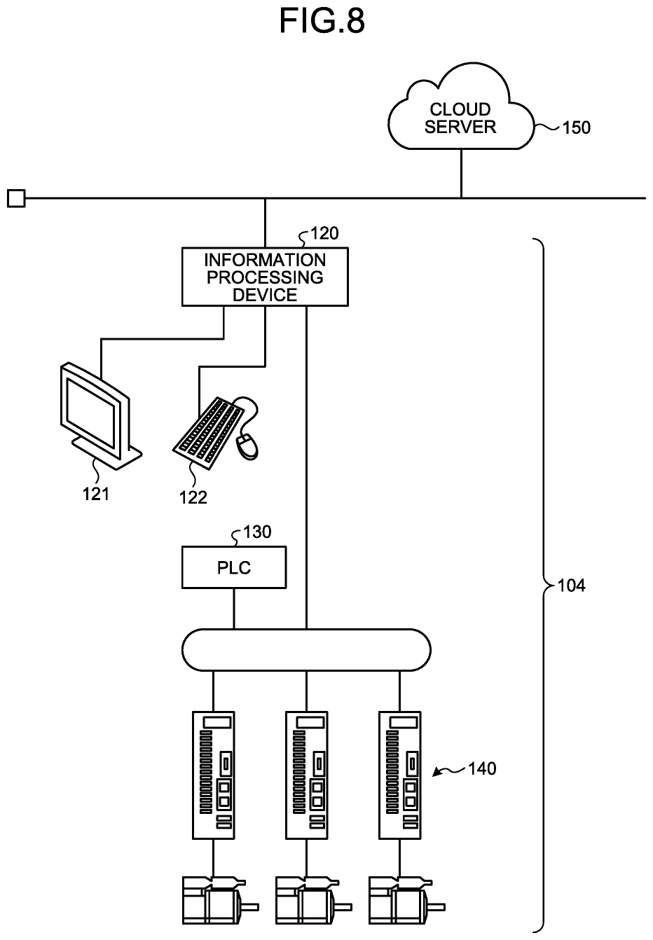

FIG. 8 is a diagram illustrating an example configuration of the virtual verification system 103 according to a fourth embodiment of the present invention. The virtual verification system 103 according to the present embodiment differs in that the functions of the real-time simulator 12 are installed in an information processing device 120. In the description below, only the differences from the first through third embodiments are explained.

The information processing device 120 in the present embodiment is connected to a cloud server 150 via a network. The information processing device 120 may be an edge computer or the like that gathers various kinds of information in the factory where the mechanical device 10 is installed, for example. The edge computer is a device that is used in a factory in an industrial equipment field, gathers information about a programmable logic controller (PLC) 130, a servo system 140, and the like in the factory via an in-factory network, and is capable of conducting examination, analysis, determination, and the like on each of the devices in real time in accordance with the information.

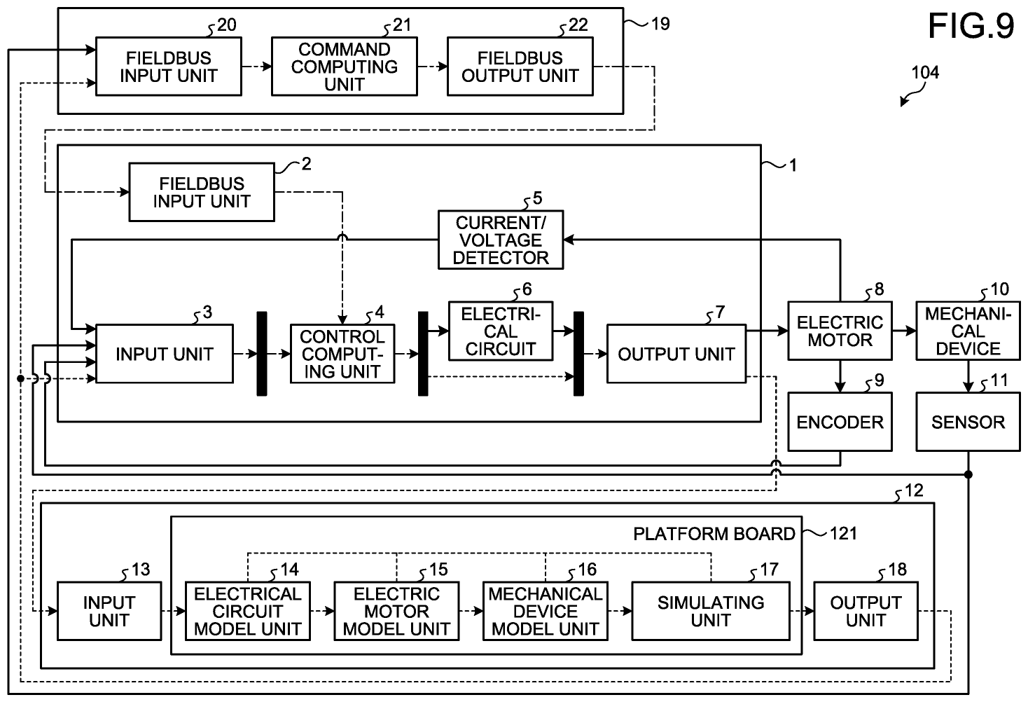

FIG. 9 is a block diagram illustrating the virtual verification system according to the present embodiment. The information processing device 120 has a platform board 121 as an optional board, and includes the electrical circuit model unit 14, the electric motor model unit 15, the mechanical device model unit 16, and the simulating unit 17 on the platform board 121.

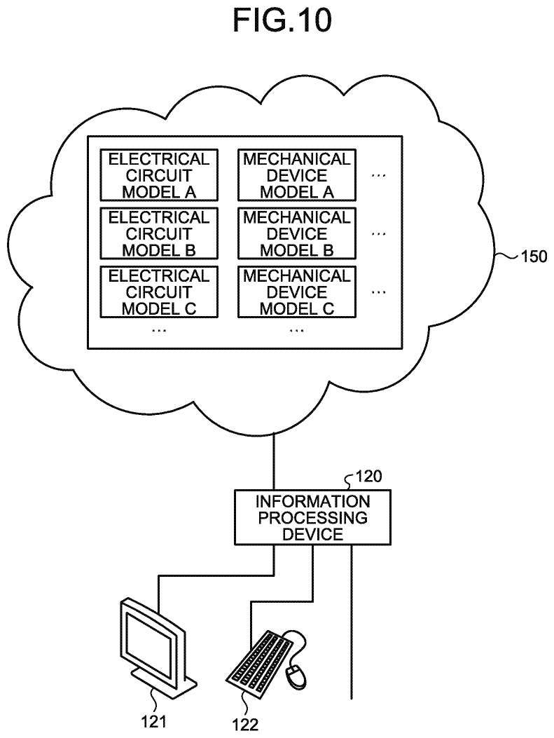

FIG. 10 is a conceptual diagram illustrating downloading of an electrical circuit model or the like from the cloud server 150 into the information processing device 120. The cloud server 150 illustrated in FIG. 10 holds electrical circuit models, electric motor models, mechanical device models, and simulation performing applications that can be installed in the information processing device 120 of the virtual verification system 103 according to the present embodiment.

As illustrated in FIG. 10, the information processing device 120 accesses the cloud server 150, checks various electrical circuit models and the like stored in the cloud, downloads the electrical model selected by the user, and installs the model into the platform board 121.

The user can download any model or application necessary for simulation from among the various models and the applications in the cloud server 150 into the information processing device 120, in accordance with the content to be verified. Thus, it is possible to change and select the simulation models installed in the information processing device 120 as appropriate.

In other words, the user operating the information processing device 120 can use an electrical circuit model suitable for a desired test or the like, or use an electrical circuit model of a desired manufacturer, for example.

Further, the various models in the cloud server 150 are accompanied by output selection signals directed to the drive controller 1. Because of this, an output selection signal is transmitted from the information processing device 120 that has downloaded a model in the cloud server 150 to the drive controller 1, so that the output signal of the control computing unit 4 is determined. Accordingly, the type of the signal to be output from the output unit 7 of the drive controller 1 is determined, and therefore, there is no need for the user to designate a signal type, for example.

Note that, in the platform board 121, the interface (I/F) portion connected to the electrical circuit model unit 14, the electric motor model unit 15, the mechanical device model unit 16, and the simulating unit 17 is a common interface, and any model units compatible with the same I/F type can be installed.

Further, the platform board 121 can control data communication between model units installed therein, and control synchronization with the model units and the simulating unit. However, the platform board 121 does not necessarily perform synchronization control.

The information processing device 120 can obtain operation information about the mechanical device 10, analyze the aging state of the mechanical device 10 in accordance with the operation information, and sends a notification of the timing to replace the mechanical parts constituting the mechanical device 10, for example. Having analyzed the operation information about the mechanical device 10, the information processing device 120 can supply the analysis result to the mechanical device model unit 16, and perform simulations taking aging degradation into consideration.

In other words, as the information processing device 120 has the platform board 121, and can install various models into the platform base, analysis result linkage among the various models becomes easier, and more advanced analyses can be conducted.

The configurations described above in the first through fourth embodiments are examples of the contents of the present invention, and can be combined with other known techniques, or may be partially omitted or modified without departing from the scope of the present invention.

### REFERENCE SIGNS LIST

1, 1a to 1c, 30, 40a to 40c drive controller; 2, fieldbus input unit; 3, 13 input unit; 4 control computing unit; 5 current/voltage detector; 6 electrical circuit; 7, 18 output unit; 8 electric motor; 9 encoder; mechanical device; 11 sensor; 12, 12a real-time simulator; 14 electrical circuit model unit; 15 electric motor model unit; 16 mechanical device model unit; 17 simulating unit; 19 controller; 21 command computing unit; 22 fieldbus output unit; 41 input signal selecting unit; 42 position/speed control unit; 43 current control unit; 44 torque constant multiplying unit; 45 PMW control unit; 46 output signal selecting unit; 100, 101, 102, 103 virtual verification system; 120 information processing device; 121 platform board; 150 cloud server.

1. A virtual verification system comprising:
real-time simulation circuitry; and
drive controller circuitry capable of being connected to the real-time simulation circuitry in a virtual verification mode, and capable of driving an electric motor in an actual operation mode,
wherein the drive controller circuitry includes
an output circuit to supply electrical power to the electric motor in the actual operation mode, and output a signal corresponding to a virtual verification model installed in the real-time simulation circuitry in the virtual verification mode.

2. The virtual verification system according to claim 1, wherein
the drive controller circuitry includes: a control computing circuit to compute an output signal; and an electrical circuit to supply electrical power to the electric motor, being controlled by the output signal, and
the electrical power supplied from the electrical circuit is output from the output circuit in the actual operation mode, and the output signal is output from the output circuit in the virtual verification mode.

3. The virtual verification system according to claim 2, wherein the control computing unit includes
an output signal selecting circuit to select an output signal in accordance with one of the actual operation mode and the virtual verification mode.

4. The virtual verification system according to claim 3, wherein the output signal selecting circuit selects a signal corresponding to a virtual verification model installed in the real-time simulation circuitry in the virtual verification mode, and sets the signal as the output signal.

5. The virtual verification system according to claim 1, wherein the drive controller circuitry includes
an input circuit to receive an input of a measurement result showing a state of the electric motor in the actual operation mode, and receive an input of simulation information simulating a state of the electric motor from the real-time simulation circuitry in the virtual verification mode.

6. The virtual verification system according to 2, wherein the output circuit includes: a first output circuit to output electrical power output from the electrical circuit to the electric motor; and a second output circuit to output a signal to be used in virtual verification to the real-time simulation circuitry.

7. The virtual verification system according to claim 1, wherein, in the virtual verification mode, a voltage lower than a power supply voltage to be supplied in the actual operation mode is input to the drive controller circuitry.

8. The virtual verification system according to claim 1, wherein the real-time simulation circuitry is mounted on an optional board.

9. The virtual verification system according to claim 8, wherein the optional board has an interface for downloading a simulation model.

10. The virtual verification system according to claim 9, wherein the optional board downloads a simulation model held in a cloud server.

11. The virtual verification system according to claim 5, wherein, when sensing that the real-time simulation circuitry is connected, the input circuit switches a mode of the drive controller circuitry to the virtual verification mode.

12. The virtual verification system according to claim 1, wherein the real-time simulation circuitry is a computer in a field network, and, in the virtual verification mode, the drive controller circuitry and the real-time simulation circuitry transmit and receive, via the field network, a signal to be used in virtual verification.

13. The virtual verification system according to claim 1, wherein the plurality of the drive controller circuitries are included, and, in the virtual verification mode, the real-time simulation circuitry is connected to the plurality of the drive controller circuitries.

14. The virtual verification system according to claim 1, wherein a plurality of the drive controller circuitries are included, and, in the virtual verification mode, the plurality of the drive controller circuitries are connected in a daisy chain form.

15. A drive controller comprising:
a control computing circuit to compute an output signal;
an electrical circuit to supply electrical power to an electric motor, being controlled by the output signal; and
an output circuit to output electrical power supplied from the electrical circuit in an actual operation mode, and output a signal corresponding to a virtual verification model installed in a real-time simulation circuitry in a virtual verification mode.

16. The drive controller according to claim 15, wherein the control computing circuit includes
an output signal selecting circuit to select an output signal in accordance with one of the actual operation mode and the virtual verification mode.

17. The drive controller according to claim 16, wherein the output signal selecting circuit selects a signal corresponding to a virtual verification model installed in the real-time simulation circuitry in the virtual verification mode, and sets the signal as the output signal.

18. The drive controller according to claim 15, wherein the output circuit includes: a first output circuit to output electrical power output from the electrical circuit to the electric motor; and a second output circuit to output a signal to be used in the virtual verification mode to the real-time simulation circuitry.
